(19) United States
(12) Patent Application Publication
(10) Pub. No.: US 2006/0131389 A1
(43) Pub. Date: Jun. 22, 2006

(54) Data card authentication system and method

(76) Inventor: Hansup Kwon, Los Altos, CA (US)

Correspondence Address: Daniel Hopen, 656 Saturn Ave, Fremont, CA, 94539, US

(21) Appl. No.: 11/015,249

(22) Filed: Dec. 16, 2004

(51) Int. Cl. G06K 5/00

(52) U.S. Cl. 235/380

(57) ABSTRACT

The present invention provides a method and an apparatus for authenticating a data card. The method for authenticating a data card having data storage comprises the steps capturing an image of the data card and comparing the image with a predetermined image to authenticate the data card. Alternatively, the method for authenticating comprises the step of receiving the data card to determine whether embossed data is present on the data card. Often, counterfeit data cards are merely cards with the data storage reprogrammed for access. By performing an image comparison between a valid card image and the incoming card image or a check for presence of embossment, counterfeit data cards are discoverable.

### FIELD

The present invention relates to authentication of a data card and, more particularly, to a method and apparatus for authenticating the data card at an automated data card terminal.

### BACKGROUND

With recent technological advancements in microprocessors and microcomputers, criminals have capitalized on these advancements to more easily steal and produce counterfeit data cards. These data cards usually have a magnetic strip or an integrated chip that is used to store information associated with the user of the data card. For example, data cards having a magnetic strip can be found on the likes of credit cards, automated teller machine (ATM) cards, driver licenses, telephone cards, identification cards, etc. Criminals perpetrating in the use and distribution of counterfeit data cards are particularly interested in cards used in financial transactions at automated teller machines, self-serviced terminals, or point of sale terminals using similar ATM cards or credit cards for the purchase of goods or services at a retail or other commercial establishment.

Due to their popularity and wide acceptance, the use of ATM cards with automated teller machines are replacing visits to traditional financial institutions for many card holders to perform their day to day banking needs and cash withdrawals. With point of sale terminals accepting ATM/debit and/or credit cards in majority of shops, restaurants, and businesses, the traditional need for a patron to carry plenty of cash currency has diminished. Consequently, the amount of fraud associated with counterfeit ATM, ATM/credit, and credit cards has been on a steady increase. Often a card holder is unaware that his/her card has been lost, stolen, or compromised. In the case of the card being lost or stolen, the card holder will normally become aware after a short period of time and report the missing card to the relevant authorities to prevent further use of the card. If however, the card is compromised, there can a longer period of time before the card holder is made aware of the situation. During this period of time, significant damage can occur to the card holder's account and financial institutions.

Data derived from criminal activities has shown that criminals will often make many copies of a compromised card and access the compromised account almost simultaneously to quickly deplete the account. Others may take a less evasive approach and make transactions that are less visible to the card holder. Criminals using commonly available machines create counterfeit cards with magnetic strips programmed with data stolen from valid data cards. The magnetic strips are programmed with essential information cloned from a compromised data card to illegally access an account. Often times, the personal identification number (PIN) associated with the stolen card has also been illicitly obtained which enables the criminals to use the counterfeit card to withdraw cash from ATMs or conduct point of sale transactions for goods and services. There are many known techniques that can be used to steal data cards and obtain PINs with new and more sophisticated techniques being continually devised. Some known schemes include vandalizing automated teller machines to trap a user's card giving the impression that the machine has retained the card. As a result the following could happen: 1) user's PIN is being observed from a distance; 2) an accomplice offers the use of a cellular phone to cancel the card which is actually another accomplice who claims to be a bank official and pretends to cancel the card with the aid of the PIN which the user gives to the feigned bank official; or 3) an accomplice advises to reenter the PIN and cancel to retrieve the card while the accomplice memorizes the PIN. There has even been instances where two devices were found attached to an ATM that were capable recording details of a user's ATM card and PIN.

It is almost impossible to prevent criminals from illegally obtaining users' card data and their PINs. As authorities foil newly discovered schemes, criminals develop new and more sophisticated schemes that are even harder to detect.

Although much progress has been made to combat counterfeit data cards, new schemes and the use of high tech equipment by the criminals are becoming increasing sophisticated and harder to detect. Accordingly, there is a need for an improved authentication method and apparatus to verify the authenticity of data cards.

### SUMMARY OF THE INVENTION

The present invention provides a data card authentication system and methods for operating the same to combat the use of fraudulent data cards at self-serviced data terminals. The novel data authentication system is based on comparing an image the data card with a valid image of the data card to authenticate the data card. Thus, according to one aspect of the invention, the method for authenticating an ATM data card having data storage comprises the steps capturing an image of the ATM data card and comparing the image with a predetermined image to authenticate the ATM data card. Since automated teller machines are unmanned, counterfeit data cards are often blank cards having the data storage of the counterfeit data card programmed to enable access to a particular account. By comparing an image of the counterfeit data card with an image of an authenticate data card, counterfeit data cards can be discovered to thwart unauthorized access to an account.

According to another aspect of the invention, the method for authenticating a data card having data storage comprises the step of receiving the data card to determine whether embossed data is present on the data card. Counterfeit data card are often blank and do not include embossment. Embossment requires additional steps that add time and cost to making the counterfeit data cards.

According to one aspect of the invention, the step of capturing the image includes capturing a front side image of the ATM data card and the step of comparing includes comparing the front side image with the predetermined image to authenticate the ATM data card. Typically, authentic ATM data cards will have image information on both sides of the ATM data card. In contrast, counterfeit data cards will often be blank and not contain any image information.

According to another aspect of the invention, the step of capturing the image includes capturing an image of the account number on the ATM data card and the step of comparing includes comparing the image of the account number with an account number stored in the data storage to authenticate the ATM data card.

According to a further aspect of the invention, the step of capturing the image includes the step of extracting from the image of the account number an extracted account number; and the step of comparing includes the step of reading a numerical account number from the data storage to compare the numerical account number with the extracted account number to authenticate the ATM data card.

According to another aspect of the invention, the method further comprises the step of retrieving from an account database a retrieved account number to match the extracted account number wherein the step of comparing includes comparing the retrieved account number with the extracted account number to authenticate the ATM data card.

Other aspects and advantages of the present invention will become apparent to those skilled in the art from reading the following detailed description when taken in conjunction with the accompanying drawings.

### BRIEF DESCRIPTION OF THE DRAWINGS

FIG. 1 is an illustration of an automated teller machine in accordance with an embodiment of the present invention;

FIG. 2 is a block diagram of an ATM card reader in accordance with an embodiment of the present invention;

FIG. 3 is a block diagram of an authentication engine in accordance with an embodiment of the present invention; and

FIG. 4 is a flow diagram showing the authentication of CCV2 code in accordance with an embodiment of the present invention.

### DETAILED DESCRIPTION

As will be described below, the present invention provides a method and an apparatus to authenticate a data card during a data card transaction such as a transaction at an automated teller machine. The invention can be used with any system that includes a data card reader to verify the validity of a data transaction card. The present invention combines traditional security measures with an additional layer of security to verify the authenticity of the data card. Generally, a data card reader captures an image of the data card to be verified which is then compared with a stored image of a valid data card. The image of the data card includes a plurality of image components that can be selectively compared and authenticated with the stored image of a valid data card. If the various image components on the imaged data card substantially match the stored image of the valid data card, then there is greater confidence that the data card is authenticate. Coupled with the traditional security measures, there is a much higher probability that the data card is indeed authentic.

In the specification and claims herein, the phrase, data card is used throughout. This phrase is understood to mean a card which can be issued by a credit card establishment, such as, Visa, Mastercard or American Express, and/or financial institution for automated teller machine (ATM) card, or debit card. Data card is also interpreted to mean a “virtual” card, e.g., a financial account which can be accessed by entering an identification number at a suitable terminal and by providing an exemplar of a signature onto a signature pad or similar device. The data card as defined herein may or may not be provided with a means to store information, such as a magnetic or optical strip located on a surface thereof, an imbedded integrated circuit die containing some form of nonvolatile memory and possibly other functional circuitry, or the like.

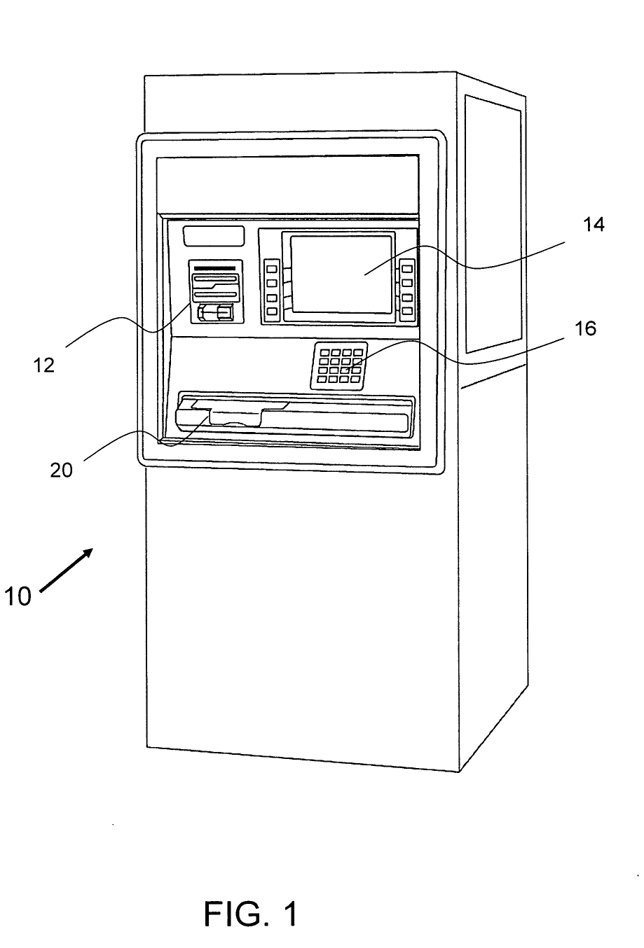

Reference will now be made to the drawings wherein like numerals refer to like parts throughout. With reference to FIG. 1, a present embodiment of the invention shows an ATM (automated teller machine) 10 having a data card input slot 12, a display screen 14, a keypad 16 and a media dispensing slot 20 such as a cash currency delivery slot.

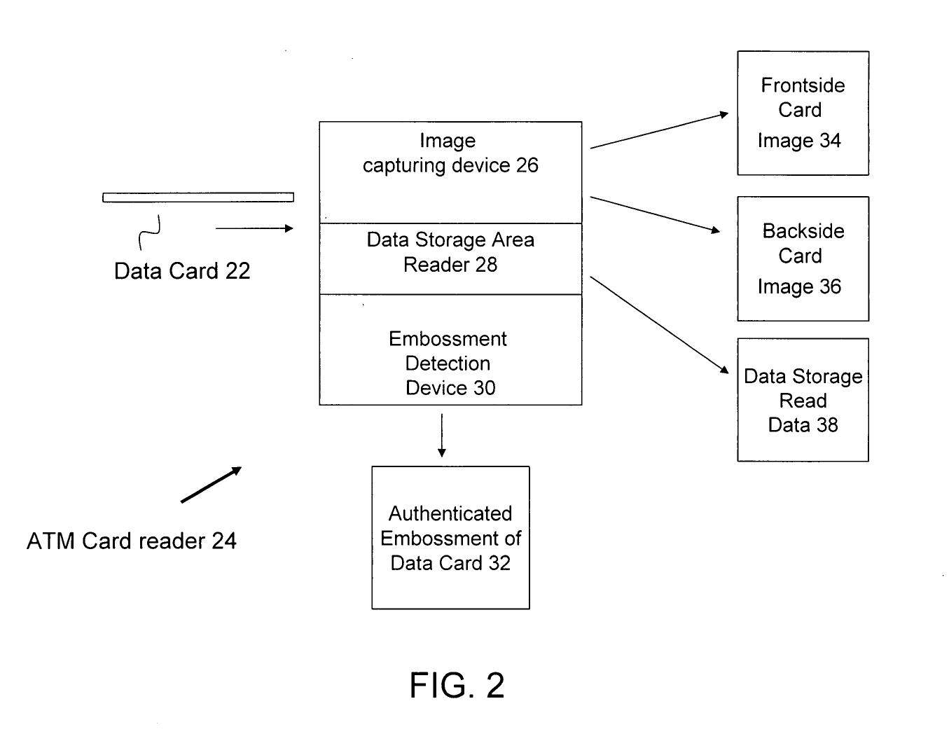

FIG. 2 illustrates a block diagram of an ATM card reader 24 according to an embodiment of the present invention. The ATM card reader 24 is affixed behind the data card input slot 12 and is configured to receive a data card 22. The ATM card reader 24 includes an image capturing device 26, data storage area reader 28, and an embossment detection device 30.

The embossment detection device 30 detects for the presence of an embossment area on the data card 22. Embossed areas, in an ATM/credit card context, represent pertinent card information such as account numbers, name of card holder, and data card expiration information. The embossed area is raised in relation to the surface of the ATM card. Traditionally, the embossment is used to enable an imprint of the pertinent card information during a face to face transaction. More often than not if not in all cases, fraudulent data cards do not include any embossment. Embossment of data cards requires more sophisticated equipment and adds additional costs to perpetrators in the business of dealing fraudulent data cards. According to an embodiment of the present invention, a first layer of security integrates an embossment detection device 30 to check for an embossment area when the ATM card reader 24 receives a data card 22. Once the embossment area is detected, the first layer of security for authenticated is complete and a next layer of security can be performed.

Further refinement of the embossment detection device 30 can include a smarter detection device that targets specific areas on the data card 22 where embossments of valid data cards are likely appear. Accordingly, instead of merely detecting embossment on a data card, the detection device can check specific areas of varying size on a surface of a data card for embossment authentication.

The image capturing device 26 captures a frontside card image 34 and a backside card image 36. The frontside card image 34 and the backside card image 36 are stored and used later for data card authentication. The data storage area reader 28 reads data from a data storage area on the data card 22 (not shown). The data storage area stores pertinent information associated with the data card 22 and may be a magnetic or optical strip (an ATM style card) and/or an imbedded integrated circuit die containing nonvolatile data storage such as a smart card or the like. In any case, the data storage area reader 28 reads data from the data storage area of the data card 22 and stores the data storage read data 46.

Accordingly, when the ATM card reader 24 receives the data card 22, the image capturing device 26 scans the frontside of the data card and captures a frontside card image 34. Similarly, the image capturing device 26 scans the backside of the data card and captures a backside card image 36. The frontside card image 34 and the backside card image 36 are stored and recalled for later use. The data storage area reader 28 also scans, for example, a magnetic strip on the data card to read the data from the magnetic strip to provide data storage read data 46 which is stored and recalled for later use.

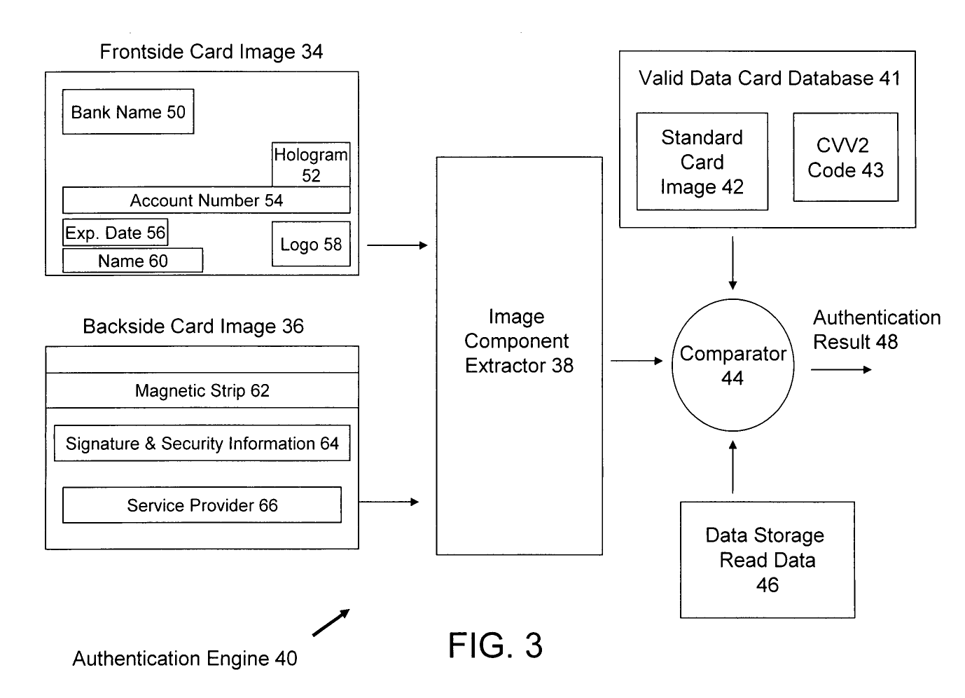

FIG. 3 illustrates a block diagram of an embodiment of an image authentication engine 40 according to the present invention. The image authentication engine 40 includes an image component extractor 38 which extracts image components from captured images of the frontside card image 34 and/or the backside card image 36 of the data card 22. Comparator 44 receives the extracted components of the frontside card image 34 and/or backside card image 36 of the data card 22 from the image component extractor 38 and compares the extracted components to components of a standard card image 42 retrieved from a valid data card database 41 and provides an authentication result 48.

An exemplary frontside card image 34 includes image components of a bank name 50, hologram 52, account number 54, expiration date 56, Logo 58 and data card holder name 60. The bank name 50 can be the name of the financial institution which issued the data card. The hologram 52 is a holographic security label which cannot be easily scanned, photocopied, or removed without destroying the hologram. Holograms are often used to combat counterfeiting. The lack of a hologram signifies the data card is likely counterfeit. The account number 54 is typically a series of numerals or an alphanumeric string. The expiration date 56 is typically a numeric representation of a month and year for the expiration date of the data card. The logo 58 is usually a mark associated with the type of data card. In the case of a credit card or debit card, the logo may indicate “MasterCard”. The name 60 is the card holder name.

An exemplary backside card image 36 includes image components of a magnetic strip 62, signature and security information 64, and service provider 66. In addition to other information encoded, the magnetic strip 62 typically repeats pertinent information that is embossed on the frontside of the data card such as card holder name, account number, bank name, and expiration date.

In one embodiment of the present invention, the image component extractor 38 retrieves a frontside card image 34 and passes the card image 34 directly to comparator 44 which retrieves a standard card image 42 from the valid card image database 41. The comparator 44 compares the frontside card image 34 with the standard card image 42. If in general the two images are substantially similar such as the size and placement of the image components on the data card, the comparator 44 issues a positive authentication result 48. If the comparison is not similar, as in the case with a blaiik fraudulent card, the comparator issues a negative authentication result 48 and can cause the ATM card reader to retain the data card. Other remedial measures can also be activated.

In a further embodiment of the present invention, the image component extractor 38 retrieves a backside card image 36 and passes the card image 36 directly to comparator 44 which retrieves a standard card image 42 having a backside image from the valid data card image database 41. The comparator 44 compares the backside card image 36 with the standard card image 42 having the backside image. If in general the two images are substantially similar, the comparator 44 issues a positive authentication result 48. If the comparison is not similar, as is often the case with counterfeit data cards which are blank, the comparator issues a negative authentication result 48 and can cause the ATM card reader to retain the data card. Other remedial measures can also be activated.

In accordance with another embodiment of the present invention, the image component extractor 38 selectively extracts a particular image component from the frontside card image 34 and/or backside card image 36. In this case, the image component extractor 38 pinpoints more precisely the particular image component in relation to the data card surface and defines the metes and bounds of the image component. Upon receipt of this information from the image component extractor 38, the comparator 44 is able to compare more precisely the selected image component with an image component from the standard card image 42 to provide a more accurate comparison and authentication result 48. A variation of the above embodiment is to extract more than one particular image component from either or both the frontside card image 34 or backside card image 36 to provide more exhaustive comparisons with the standard card image 42.

For example, the image component extractor 38 selects the image component for signature and security information 64 and extracts the signature from the image component. Once extracted, the comparator can search the valid data card database 41 for a similar image of the signature. If a substantial match is found, a positive authentication result 48 is issued. On the other hand, if no match can be found from the valid data card database 41, a negative authentication result 48 is issued and proper remedial measure can be implemented.

In accordance with a refinement of the above embodiments of the present invention, the image component extractor 38 includes an advanced extractor engine such as an optical character recognition (ocr) engine or comparable device to ocr or extract numeric or alphanumeric data from the various image components. For example, from the image component of account number 54, the extractor engine of the image component extractor 38 extracts the account information from the frontside card image 34 of the data card 22. The numeric account number, which can include alphanumeric characters, is passed to the comparator 44 which retrieves the data storage read data 46 and a comparison of the account information is performed. If the account information matches the authentication result 48 is positive and is negative if the account information does not match.

Any one or more of the image components can be extracted to distill alphanumeric characters which can then be compared for exact match with the data storage read data 46. Those image components on the frontside card image 34 include bank name 50, account number 54, expiration date 56, and card holder name 60. Those image components on the backside card image 36 include the signature and security information 64.

The image component for signature and security information 64 includes CVV2 (also known as CVC2 or CID) information that is not encoded in the magnetic strip 62. The CVV2 is a three or four digit value that is uniquely derived for each data card account. CVV2 number are not PIN (personal identification number) codes but rather are a number linked to a data card by card agencies which can be used to validate card numbers. Because CVV2 numbers are printed directly on the data card, the CVV2 numbers are proof that the user has possession of the data card provide another layer of security to keep data cards safe and reduce complications associated with fraudulent use. In a card-not-present environment such as orders placed using Facsimile or the Internet, CVV2 lets a merchant verify that the cardholder does in fact have the card in his/her possession. Often, the placement of the CVV2 code is in the image component for signature and security information 64. For example, on Visa and MasterCard cards, it is a three digit value printed in reverse italic characters on the signature panel following the last 4 digits of the account number. However, on American Express cards, it is a four digit value printed on the frontside of the card, usually on the right side. It is conceivable that the CVV2 code in the future may include an alphanumeric representation.

In the following embodiment of the present invention, the extractor engine of the image component extractor 38 extracts the signature and security information 64 from the backside card image 36 of the data card 22 to distill a CVV2 code. The CVV2 code is passed to the comparator 44 which attempts to retrieve from the valid data card database 41 a matching CVV2 code 43 to perform a comparison of the extracted CVV2 code and the retrieved CVV2 code. If the CVV2 codes match, the authentication result 48 is positive and is negative if the CVV2 codes do not match.

Alternatively, since the CVV2 codes are stored as data in the magnetic strip 62, the comparator 44 retrieves the data storage read data 46 and performs a comparison of the extracted CVV2 code with the CVV2 code retrieved from the data storage read data 46. If the CVV2 codes match, the authentication result 48 is positive and is negative if the CVV2 codes do not match.

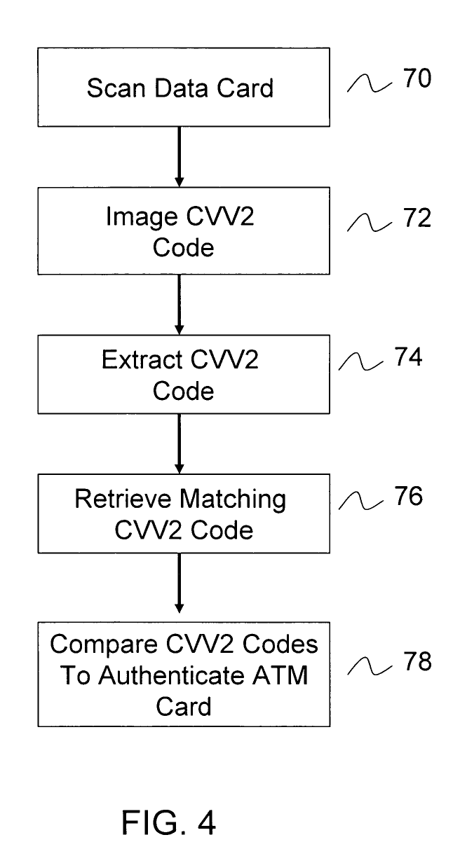

FIG. 4 illustrates a flow diagram in accordance with an embodiment of the present invention as applied to a data card having a CVV2 code. The flow diagram begins with step 70 in which the card reader receives the data card and scans an image of the data card. In step 72, the card reader extracts an image of the CVV2 code. Depending on which financial institution is associated with the data card, the CVV2 code may be on the frontside or the backside of the ATM card. Most common are data cards associated with Visa and MasterCard which locate the CVV2 code on the backside in the signature and security information block. In step 74, an extractor engine extracts from the image of signature and security information block a CVV2 code. Next, in step 76, the comparator retrieves from the data storage read data 46 a data storage CVV2 code. In step 78, a comparison is performed between the extracted CVV2 code and the data storage CVV2 code. If a match is found, the data card is authenticated. If a match is not found, the data card is likely counterfeit and proper countermeasures can be implemented.

It should be noted that the many parts of the authentication engine 40 may be remotely located. For example, the valid data card database 41 can be located at a central location serving many data card authentication machines. Similarly, the comparator 44 may also be located at the central or a different location. Accordingly, frontside card image data and/or backside card image data, and data storage read data may be transmitted via a communication link to a central location for processing.

While the foregoing detailed description has described several embodiments of the present invention, it is to be understood that the above description is illustrative only and not limiting of the disclosed invention. Obviously, many modifications and variations will be apparent to those skilled in the art without departing from the spirit of the invention.

I claim:

1. A method for authenticating a data card having data storage, comprising the step of receiving the data card to determine whether embossed data is present on the data card.

2. A method for authenticating an ATM data card having data storage, comprising the steps:
capturing an image of the ATM data card; and
comparing the image with a predetermined image to authenticate the ATM data card.

3. The method of claim 2, wherein:
the step of capturing the image includes capturing a front side image of the ATM data card; and
the step of comparing includes comparing the front side image with the predetermined image to authenticate the ATM data card.

4. The method of claim 3, wherein:
the step of capturing the image includes capturing an image of a hologram on the ATM data card; and
the step of comparing includes comparing the image of the hologram with a predetermined image of a hologram to authenticate the ATM data card.

5. The method of claim 3, wherein:
the step of capturing the image includes capturing an image of an issuer name or logo on the ATM data card; and
the step of comparing includes comparing the image with a predetermined image of an issuer name or logo to authenticate the ATM data card.

6. The method of claim 3, wherein:
the step of capturing the image includes capturing an image of the account number on the ATM data card; and
the step of comparing includes comparing the image of the account number with an account number stored in the data storage to authenticate the ATM data card.

7. The method of claim 6 wherein:
the step of capturing the image includes the step of extracting from the image of the account number an extracted account number; and
the step of comparing includes the step of reading a numerical account number from the data storage to compare the numerical account number with the extracted account number to authenticate the ATM data card.

8. The method of claim 7 further comprising the step of retrieving from an account database a retrieved account number to match the extracted account number wherein the step of comparing includes comparing the retrieved account number with the extracted account number to authenticate the ATM data card.

9. The method of claim 2, wherein:
the step of capturing the image includes capturing a backside image of a backside of the ATM data card; and
the step of comparing includes comparing the backside image with a predetermined image of the backside to authenticate the ATM data card.

10. The method of claim 9 wherein:
the step of capturing the image includes capturing a service provider on the backside of the ATM data card; and
the step of comparing includes comparing the service provider with a predetermined image of the service provider.

11. The method of claim 9, wherein:
the step of capturing the image includes capturing a signature block image; and
the step of comparing includes comparing the signature block image with a predetermined image of a signature block.

12. The method of claim 11 further comprising the steps of:
extracting from the signature block image an imaged signature; and
retrieving a saved signature image from a signature database to match the imaged signature wherein the step of comparing includes matching the saved signature image with the imaged signature to authenticate the ATM data card.

13. The method of claim 12, wherein the steps of:
extracting includes extracting the imaged security code to provide a numeric security code; and
retrieving includes retrieving a valid security code to match the numeric security code wherein the step of comparing matches the numeric security code with the valid security code.

14. A data card authentication apparatus for authenticating a data card having a data storage area, comprising:
a card reader configured to receive the data card and extract data from the data storage area, the card reader includes an embossed data detector configured to detect embossed data on the data card; and
an authenticator coupled to the embossed data detector configured to authenticate the data card upon detection of embossed data.

15. An ATM card authentication apparatus for authenticating an ATM data card having a data storage area, comprising:
a card reader configured to receive the ATM data card and read card data from the data storage area, the card reader includes an imager configured to capture an input image of the ATM card;
an ATM card image database configured to store a valid image of a valid ATM data card; and
a comparator operatively coupled to the card reader and the image database configured to retrieve the valid image and compare the input image with the valid image to authenticate the ATM data card.

16. The ATM card authentication apparatus of claim 15 further comprising:
a data extractor configured to extract the input image data and provide extracted data; and wherein:
the card reader reads card data from the data storage area; and
the comparator compares the extracted data with the card data to authenticate the ATM data card.

17. The ATM card authentication apparatus of claim 16, wherein the card data includes account data, name of account holder, expiration date, or bank identification number.

18. The ATM card authentication apparatus of claim 16, wherein:
the input image data includes a CVV2 code and the data extractor provides an extracted CVV2 code;
the card reader reads card CVV2 code from the data storage area; and
the comparator compares the card CVV2 code with the extracted CVV2 code to authenticate the CVV2 code.

19. The ATM card authentication apparatus of claim 15, wherein:
the imager captures a backside image of a backside of the ATM data card;
the ATM card image database stores a valid backside image of the ATM data card; and
the comparator retrieves the valid backside image and compares the backside image with the valid backside image to authenticate the ATM data card.

20. The ATM card authentication apparatus of claim 15, wherein the data storage area comprises a magnetic strip.
